(19) United States
(12) Patent Application Publication
(10) Pub. No.: US 2026/0138279 A1
(43) Pub. Date: May 21, 2026

(54) ROBOTIC LOAD SYSTEMS AND EFFECTORS TO ENGAGE OBJECTS

(71) Applicant: COLLABORATIVE ROBOTICS, Santa Clara, CA (US)

(72) Inventors: Alan Baird, Redwood City, CA (US); Courtney Kobata, Daly City, CA (US)

(21) Appl. No.: 19/396,290

(22) Filed: Nov. 20, 2025

Related U.S. Application Data
(60) Provisional application No. 63/722,977, filed on Nov. 20, 2024.

(51) Int. Cl. B25J 9/16; B25J 5/00

(52) U.S. Cl. CPC B25J 9/1694; B25J 5/007

(57) ABSTRACT

A robot may include a load system including an interface device configured to engage with objects including different features. The robot may include a control system configured to detect a current feature of a current object. The control system may also be configured to cause the load system to be positioned based on the current feature of the current object to cause the interface device to engage with the current object.

### CROSS-REFERENCE TO RELATED APPLICATION

This patent application claims the benefit of and priority to U.S. Provisional App. No. 63/722,977 filed Nov. 20, 2024, titled “MANIPULATOR ELEMENTS OF ROBOTS,” which is incorporated in the present disclosure by reference in its entirety.

### FIELD

Embodiments described herein relate to robotic load systems and effectors to engage objects.

### BACKGROUND

Unless otherwise indicated in the present disclosure, the materials described in the present disclosure are not prior art to the claims in the present application and are not admitted to be prior art by inclusion in this section.

Robots include load systems configured to engage with objects to manipulate the objects. For example, the load system may move, assemble, sort, stack, orient, open, close, place, or any other appropriate action relative to the object. The robots may operate in various manufacturing, warehouses, logistics, and delivery settings.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a robot. The robot may include a load system including an interface device configured to engage objects including different features. The robot may also include a control system configured to detect a current feature of a current object. In addition, the control system may be configured to cause the load system to be positioned based on the current feature of the current object to cause the interface device to engage with the current object.

One or more embodiments of the present disclosure may include a robot. The robot may include a support portion. The robot may also include a load system coupled to the support portion. In addition, the load system may include an interface device configured to engage with objects including different features. Further, the load system may include an appendage assembly configured to pivot around a first axis to permit a first link of the appendage assembly to move relative to the support portion. The appendage assembly may also be configured to pivot around a second axis to permit a second link of the appendage assembly to move relative to the first link. The appendage assembly may be configured to pivot around a third axis to permit a third link of the appendage assembly to move relative to the second link. The appendage assembly may be configured to pivot around the first axis, the second axis, and the third axis to position the load system and cause the interface device to engage with the objects including the different features.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which a robot that includes a load system may operate;

FIG. 2 illustrates an example of the robot of FIG. 1 in which the load system includes an appendage assembly;

FIG. 3 illustrates a detailed view of a portion of the appendage assembly of FIG. 2;

FIGS. 4A-4C illustrate additional examples of the robot of FIG. 1 in which the load system includes suction cups;

FIG. 5 illustrates another example of the robot of FIG. 1 in which the load system includes articulating interfaces;

FIGS. 6A and 6B illustrate yet another example of the robot of FIG. 1 in which the load system includes expandable interface portions;

FIGS. 7A and 7B illustrates an example of the robot of FIG. 1 in which the load system includes fractal devices;

FIG. 8 illustrates another example of the robot of FIG. 1 in which the load system includes belts and tensioners;

FIG. 9 illustrates yet another example of the robot of FIG. 1 in which the load system includes an interface portion;

FIG. 10 illustrates a further example of the robot of FIG. 1 in which the load system includes a rotatable portion;

FIGS. 11A-11D illustrate a sequence of views of an example interface device that includes a rotatable portion;

FIGS. 12-16B illustrate another example of the robot of FIG. 1 in which the load system includes an adjustable interface assembly; and

FIG. 17 illustrates an example computing system that may be used for positioning the load system,

all according to at least one embodiment described in the present disclosure.

### DETAILED DESCRIPTION

Some robots may include fixed load systems that are designed for specific tasks and/or to engage with specific objects. These fixed load systems may limit the adaptability of the robots and prevent the robots from engaging objects with different features (e.g., varying heights, shapes, sizes, orientations, types for engagement, distances from the robot, or any other appropriate feature). The types for engagement may include edges, generally vertical surfaces, or generally horizontal surfaces (e.g., a box, container, or crate) for the robot to engage with. The types for engagement may also include handles (e.g., carts or other objects that include mobility features) for the robot to engage with.

To engage with the objects with different features, multiple robots with different fixed load systems may be deployed. Using multiple robots with different fixed load systems may result in some of the robots waiting idle when there are no objects that they are compatible to engage with. This may reduce an efficiency of the robots completing tasks. Additionally or alternatively, the robots may swap fixed load systems when engaging objects with different features than what a current fixed load system is compatible with. The robots swapping the fixed load systems may introduce delays to completing tasks due to the time used to swap the fixed load systems.

Therefore, there is a need for a robot that includes a load system that is adjustable to allow the robot to engage with objects with different features.

A robot in accordance with embodiments described in the present disclosure may include a load system that is adjustable to allow the robot to engage with objects with different features. The load system may allow the robot to engage with objects with varying shapes and/or sizes; that include different types of portions to engage with; that are positioned at various heights, distances, or with various orientations relative to the robot, or some combination thereof.

A robot in accordance with embodiments described in the present disclosure may include a load system including an interface device configured to engage objects including different features. The robot may also include a control system configured to detect a current feature of a current object. In addition, the control system may be configured to cause the load system to be positioned based on the current feature of the current object to cause the interface device to engage with the current object.

A robot in accordance with embodiments described in the present disclosure may include a support portion. The robot may also include a load system coupled to the support portion. The load system may include an interface device configured to engage with objects including different features. Further, the load system may include an appendage assembly configured to pivot around a first axis to permit a first link of the appendage assembly to move relative to the support portion. The appendage assembly may also be configured to pivot around a second axis to permit a second link of the appendage assembly to move relative to the first link. The appendage assembly may be configured to pivot around a third axis to permit a third link of the appendage assembly to move relative to the second link. The appendage assembly may be configured to pivot around the first axis, the second axis, and the third axis to position the load system and cause the interface device to engage with the objects including the different features.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

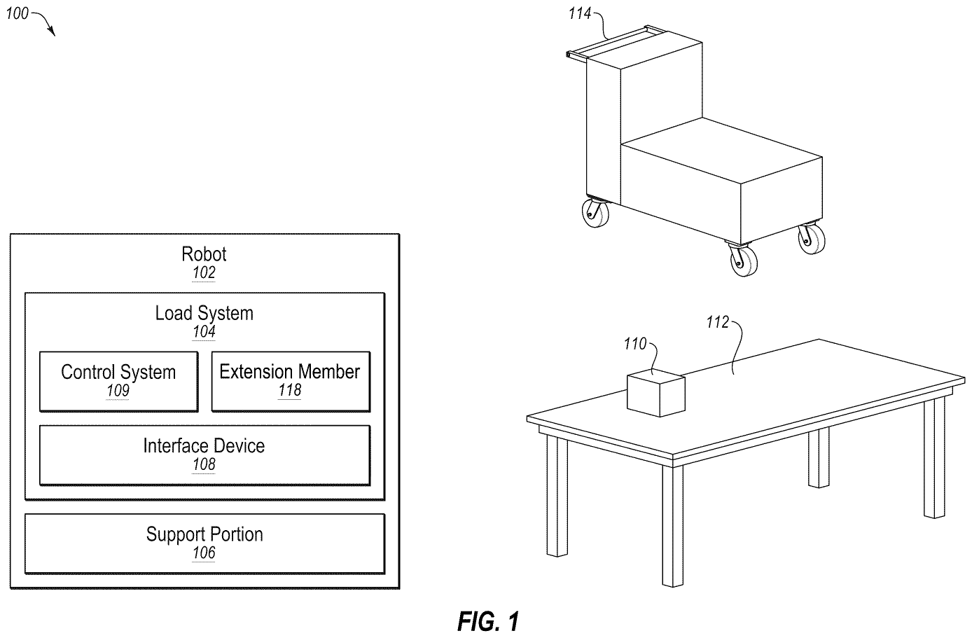

FIG. 1 illustrates a block diagram of an example operational environment 100 in which a robot 102 may operate, in accordance with at least one embodiment described in the present disclosure. The environment 100 may include any location in which the robot 102 may operate. For example, the environment 100 may include a warehouse, a hospital, a campus, a building, a field, a construction site, and the like.

The environment 100 may include various elements that facilitate the operation of the robot 102. For example, the environment 100 may include a first object 110 positioned on a table 112. The first object 110 may represent a stationary object that does not include mobility features and is configured to be moved by the robot 102. The first object 110 is shown in FIG. 1 as a box for example purposes. The first object 110 may include any appropriate stationary object. The environment 100 may also include a second object 114. The second object 114 is shown in FIG. 1 as a cart that includes a handle and mobility features (e.g., wheels) for example purposes. The second object 114 may include any object configured to be moved by being pushed or pulled by the robot 102.

The robot 102 may include a load system 104 that includes an interface device 108 configured to engage with the objects 110, 114. The objects 110, 114 may include different features that affect how the robot 102 engages with the objects 110, 114. The different features of the objects 110, 114 may include different heights, shapes, widths, depths, lengths, orientations relative to the robot 102, sizes, mobility features, types for engagement, or any other appropriate feature or structural feature of the objects 110, 114. For example, the interface device 108 may be configured to engage with instances of the first object 110 that include different sizes or are positioned different distances from the robot 102. As another example, the interface device 108 may be configured to engage with instances of the second object 114 that include handles of different sizes, shapes, or heights. As yet another example, the interface device 108 may be configured to transition between states to be able to engage with both the first object 110 and the second object 114.

The robot 102 may use the load system 104 to move or manipulate the objects 110, 114. For example, the load system 104 to engage with the first object 110 to transfer the first object 110 from the table 112 on to the robot 102, from the table 112 on to the second object 114, or from the table 112 to another location within the environment 100. As another example, the robot 102 may use the load system 104 to engage with and manipulate the first object 110 to assemble, sort, stack, orient, open, close, place, or any other appropriate action relative to the first object 110. As yet another example, the robot 102 may use the load system 104 to engage with the second object 114 to push or pull the second object 114 within the environment 100.

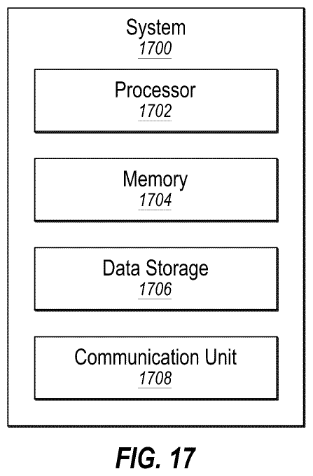

The load system 104 may include a control system 109 that includes a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 17.

The control system 109 may facilitate the load system 104 engaging the objects 110, 114. The control system 109 may detect the features (e.g., current features) of the objects 110, 114. The control system 109 may detect the features of the objects 110, 114 by analyzing visual data, sensor data, or other data received via sensors (not shown) or operators (not shown).

The control system 109 may cause the load system 104 to be positioned based on the features of the objects 110, 114 to cause the interface device 108 to engage with the objects 110, 114. As used herein, positioning the load system 104 may include adjusting one or more of a configuration, a position, or a characteristic of the load system 104 to enable engagement of the interface device 108 with the objects 110, 114. As described in more detail below, positioning the load system 104 may include adjusting a width, a height, a configuration of one or more parts of the load system 104. For example, the control system 109 may cause a support portion 106 of the robot 102 to move the load system 104 along a height of the support portion 106 to adjust a height of the interface device 108. As described in more detail below, positioning the load system 104 may include adjusting a characteristic of the interface device 108 to permit the interface to engage with the different instances of the objects 110, 114 when the features of the objects 110, 114 are different (e.g., a current instance of the objects 110, 114 has different features than previous instances of the objects 110, 114). For example, the control system 109 may cause the load system 104 to be positioned to permit the interface device 108 to accommodate the objects 110, 114 having different dimensions.

The support portion 106 may include an actuator (not shown) configured to move the load system 104 along a height of the support portion 106 (e.g., raise or lower the load system 104). For example, the control system 109 may activate the actuator to cause the load system 104 to be moved along the height of the support portion 106. Moving the load system 104 along the height of the support portion 106 may permit the interface device 108 to engage with the objects 110, 114 at a variety of heights.

The load system 104 may include an extension member 118. In some embodiments, the extension member 118 may be omitted. The extension member 118 may extend or retract to adjust a length or reach of the interface device 108. The extension member 118 may extend and retract to increase or decrease a distance between the interface device 108 and the support portion 106. The extension member 118 extending or retracting may permit the interface device 108 to engage with the objects 110, 114 at a variety of distances from the support portion 106.

The control system 109 may cause the extension member 118 to extend or retract to adjust the reach or the length of the interface device 108 to account for the objects 110, 114 being positioned at different distances from the robot 102 (e.g., to account for the different features of the objects 110, 114). The extension member 118 extending or retracting may permit the interface device 108 to engage with the objects 110, 114 at a variety of distances from the robot 102.

The environment 100 is shown in FIG. 1 as including single instances of the objects 110, 114 for example purposes. The environment 100 may include any appropriate number of either of the objects 110 or 114. For example, the environment 100 may include multiple instances of the first object 110, multiple instances of the second object 114, or multiple instances of both.

The instances of the first object 110 may include uniform containers, uniform packages, non-uniform containers, non-uniform packages, or any other object type. The uniform containers and/or uniform packages may include the same shapes, sizes, weights, or some combination thereof. The non-uniform containers and/or non-uniform packages may include different shapes, sizes, weights, or some combination thereof. Additionally or alternatively, the instances of the first object 110 may be positioned at different heights and/or distances relative to the robot 102. For example, a first instance of the first object 110 may be positioned one foot from an edge of the table 112 to which the robot 102 can position itself and a second instance of the first object 110 may be positioned two feet from the edge of the table 112.

The instances of the second object 114 may include uniform carts and/or non-uniform carts. The uniform carts may include handles with the same shapes, sizes, weights, heights, or some combination thereof. The non-uniform carts may include handles with different shapes, sizes, weights, heights or some combination thereof. As used herein, the term “cart” may encompass any object that includes a handle and/or mobility features to facilitate movement of the second object 114 from one location to another within the environment 100.

In the present disclosure, when the load system 104, the interface device 108, or any portion of the load system 104 or the interface device 108 is described as moving, it is to be understood that this may include the control system 109 activating one or more actuators to cause the movement.

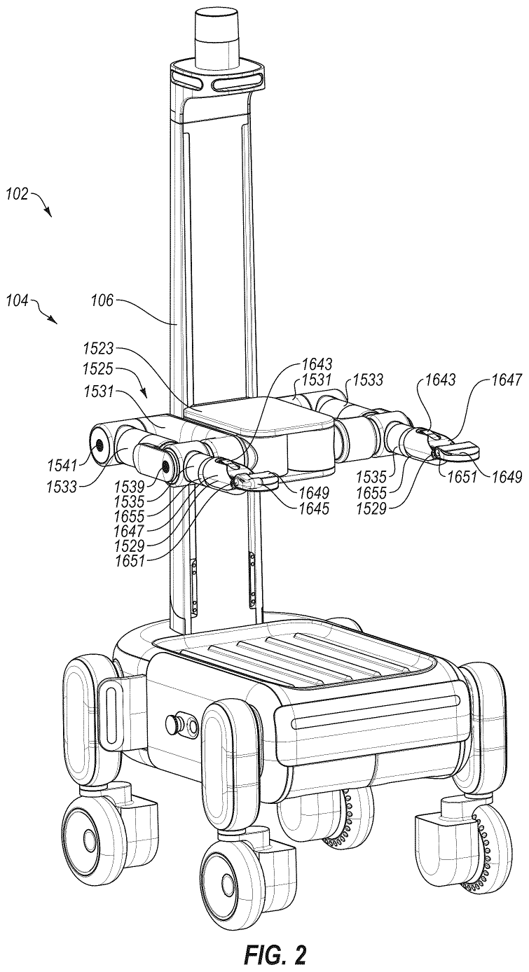

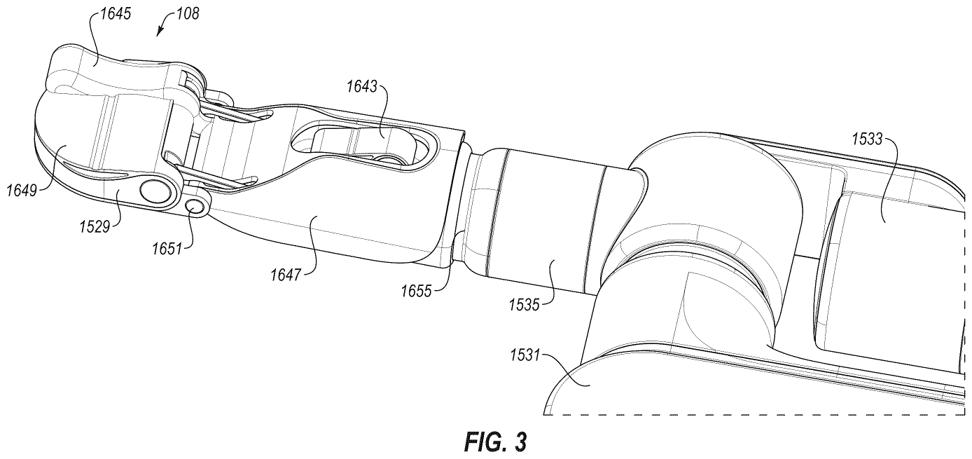

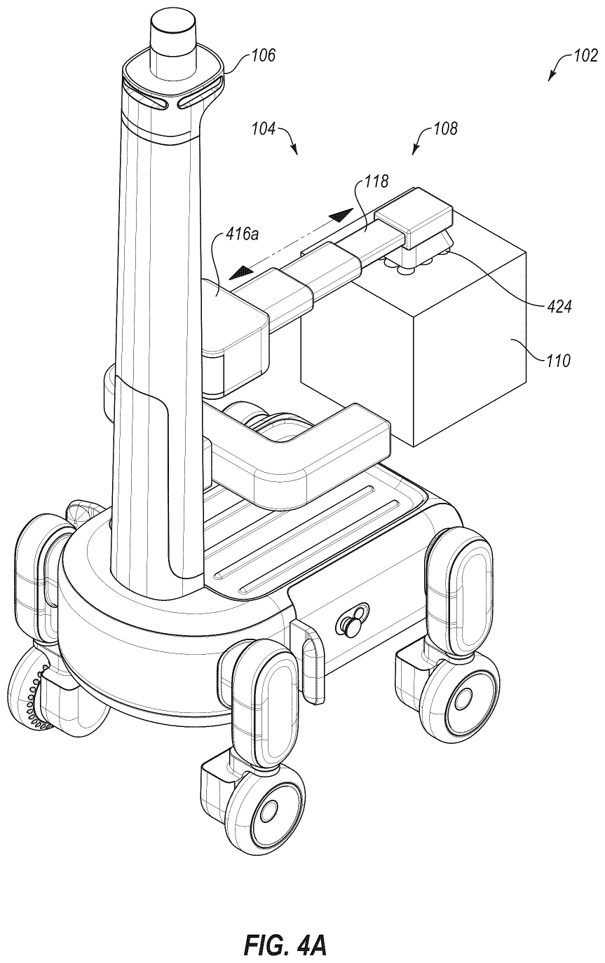

FIG. 2 illustrates an example of the robot 102 of FIG. 1 in which the load system 104 includes an appendage assembly 1525, in accordance with at least one embodiment described in the present disclosure. FIG. 3 illustrates a detailed view of a portion of the appendage assembly 1525 of FIG. 2, in accordance with at least one embodiment described in the present disclosure. The appendage assembly 1525 may provide three degrees of freedom of the load system 104.

Referring to FIGS. 2 and 3, the robot 102 may include the support portion 106 coupled to the load system 104. The load system 104 may include a body 1523 that is coupled to the support portion 106 and the appendage assembly 1525. As described in more detail below, links 1531, 1533, 1535 of the appendage assembly 1525 may pivot around a first axis (shown in FIG. 2 as a first axis 1539), a second axis (shown in FIG. 2 as a second axis 1541), or a third axis (shown in FIG. 2 as the first axis 1539) to permit the links 1531, 1533, 1535 to move relative to the body 1523, the support portion 106, or each other. The links 1531, 1533, 1535 may pivot around the different axes 1539, 1541 to position the load system 104 and cause the interface device 108 to engage with the objects 110, 114 at different heights, distances from the robot, or in different orientations (e.g., to account for the features of the objects 110, 114).

The first link 1531 may pivot around the first axis 1539 to change an orientation of the first link 1531 relative to the support portion 106. For example, the control system 109 may activate an actuator (not shown) to cause the first link 1531 to move and change the orientation of the first link 1531. The orientation of the first link 1531 may be changed independent of an orientation of the second link 1533 or the third link 1535. The orientation of the first link 1531 may be changed to move the second link 1533, the third link 1535, or the interface device 108. The first link 1531 may pivot around the first axis 1539 to move the first link 1531 along a vertical plane. The actuator may cause the first link 1531 to move independent of the second link 1533 or the third link 1535. The movement of the first link 1531 may cause the second link 1533 and the third link 1535 to move along corresponding vertical planes.

The second link 1533 may pivot around the second axis 1541 to change the orientation of the second link 1533 relative to the first link 1531. For example, the control system 109 may activate an actuator (not shown) to cause the second link 1533 to move and change the orientation of the second link 1533. The orientation of the second link 1533 may be changed independent of the orientation of the first link 1531 or the third link 1535. The orientation of the second link 1533 may be changed to move the third link 1535 or the interface device 108. The second link 1533 may pivot around the second axis 1541 to move the second link 1533 along a vertical plane. The actuator may cause the second link 1533 to move independent of the first link 1531 or the third link 1535. The movement of the second link 1533 may cause the third link 1535 to move along a corresponding vertical plane.

The third link 1535 may pivot around the first axis 1539 to change the orientation of the third link 1535 relative to the second link 1533. For example, the control system 109 may activate an actuator (not shown) to cause the third link 1535 to move and change the orientation of the third link 1535. The first axis 1539 is illustrated in FIG. 2 as indicating the axis around which the first link 1531 and the third link 1535 both rotate when the links 1531 and 1535 are aligned relative to each other. However, movement of the first link 1531 and/or the second link 1533 along the corresponding axes may cause the third link 1535 to not be aligned with the first link 1531 and the axis around which the third link 1535 may be offset from the axis around which the first link 1531 rotates. In other words, the axis around which the third link 1535 rotates may move with the third link 1535.

The orientation of the third link 1535 may be changed independent of the orientation of the first link 1531 or the second link 1533. The orientation of the third link 1535 may be changed to move the interface device 108. The third link 1535 may pivot around the first axis 1539 to move the third link 1535 along a vertical plane. The actuator may cause the third link 1535 to move independent of the first link 1531 or the second link 1533.

The orientations of the links 1531, 1533, or 1535 may be changed to adjust a reach of the appendage assembly 1525 to permit the appendage assembly 1525 to engage with the objects 110, 114 at different heights or distances from the support portion 106. In addition, the links 1531, 1533, or 1535 may pivot around the axes 1539, 1541 to provide three degrees of freedom for the appendage assembly 1525.

The interface device 108 may include effectors 1529 that are coupled to the third links 1535. The effectors 1529 may transition between states to permit the load system 104 to engage with both the first object 110 and the second object 114. For example, the effectors 1529 may be in an uncurled state to engage with the first object 110. As another example, the effectors 1529 may be in a curled state to engage with the second object 114 or the first object 110 including edges, corners, or other appropriate features. The effectors 1529 are shown in FIGS. 2 and 3 in the uncurled state.

The effectors 1529 may include first portions 1647 coupled to the corresponding third links 1535. The first portions 1647 may be coupled to the third links 1535 via rotational joints 1655. The rotational joints 1655 may include actuators (not shown) configured to rotate the corresponding effector 1529 (e.g., the first portions 1647) to change an orientation of the effectors 1529. For example, the control system 109 may activate the actuator to cause the rotational joints 1655 to rotate and change the orientation of the effectors 1529 relative to the third links 1535.

The effectors 1529 may include second portions 1649 coupled to the first portions 1647. The second portions 1649 may pivot around axes 1651 to facilitate movement of the second portions 1649 relative to the first portions 1647. For example, the second portions 1649 may pivot around the axes 1651 to cause the effectors 1529 to transition between the curled state and the uncurled state. (e.g., open or close palms of the effectors 1529).

The effectors 1529 may transition to or be in the curled state to permit the interface device 108 to engage with corners or edges of the first object 110. Additionally or alternatively, the effectors may transition to or be in the curled state to permit the interface device 108 to engage with the handle of the second object 114.

In the curled state, the second portions 1649 may extend from the first portions 1647 at an angle that is not parallel to an axis of the third links 1535 such that the interface device 108 can grip a corner or edge of the first object 110. Additionally or alternatively, in the curled state, the second portions 1649 may extend from the first portions 1647 at the angle that is not parallel to the axis of the third links 1535 to permit the interface device 108 to cradle the handle of the second object 114.

The effectors 1529 (e.g., the interface device 108) may include first grippers 1643 or second grippers 1645. The first grippers 1643 or the second gripper 1645 may transition between a curled state and an uncurled state to permit the interface device 108 to engage with the objects 110, 114. The first grippers 1643 and the second gripper 1645 are shown in FIGS. 2 and 3 in the uncurled state. In the curled state, the first grippers 1643, the second gripper 1645, or both may be curled to grip a handle or other portion of the second object 114 or an edge or other feature of the first object 110.

The first grippers 1643, the second gripper 1645, or both may include soft materials to prevent damage when engaging the objects 110, 114. The first grippers 1643, the second gripper 1645, or both may include tacky materials to create friction between the objects 110, 114 and the effectors 1529.

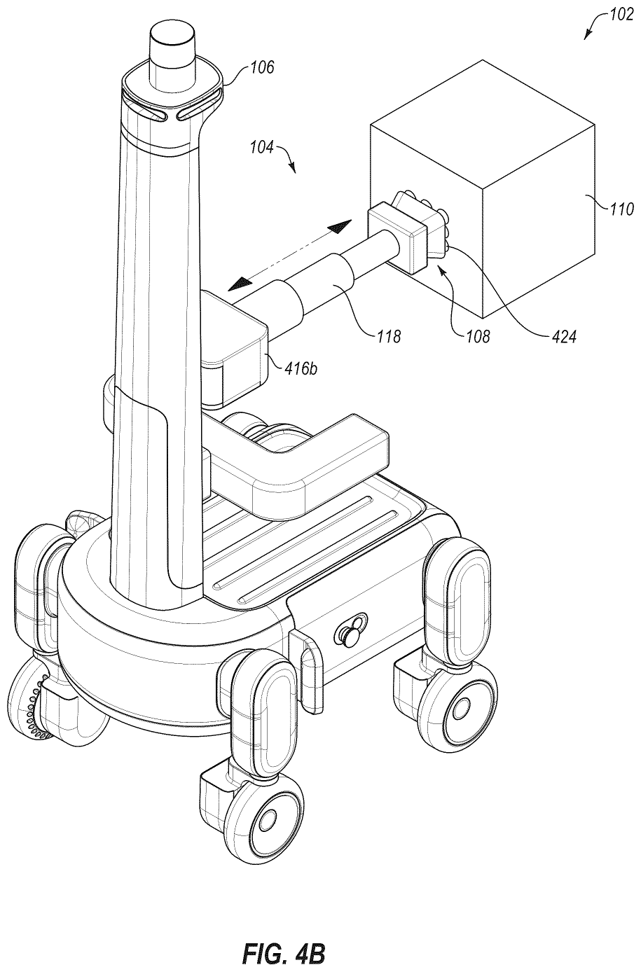

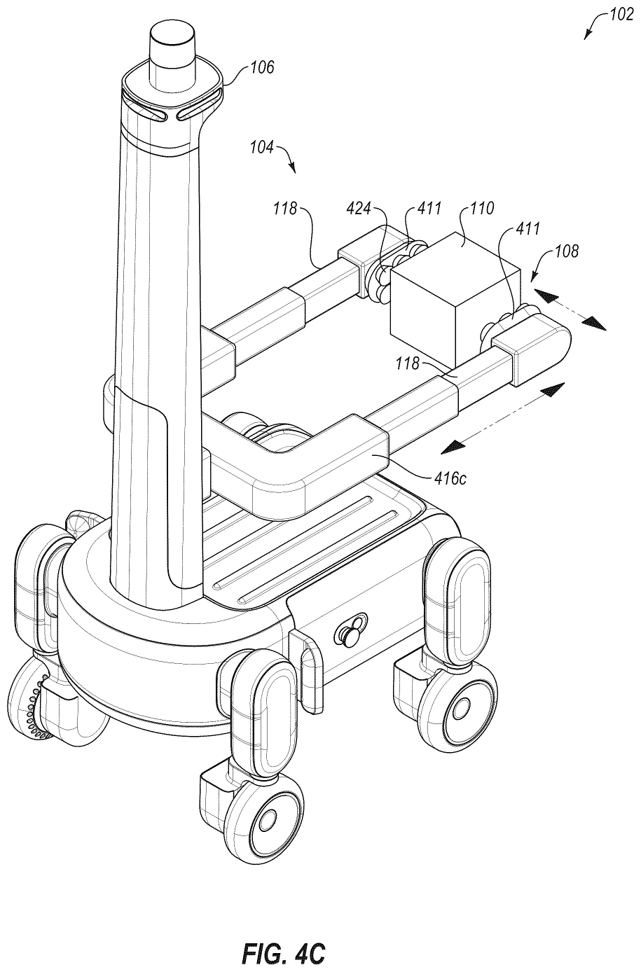

FIGS. 4A-4C illustrate additional examples of the robot 102 of FIG. 1 with load systems 104 that include suction cups 424, in accordance with at least one embodiment described in the present disclosure. With combined reference to FIGS. 4A-4C, the robot 102 includes the support portion 106 coupled to the load system 104. The load system 104 may include the extension member 118 coupled to the interface device 108. The load system 104 may include bodies 416a-c coupled to the extension member 118 and the support portion 106.

The control system 109 may cause the extension member 118 to extend or retract to adjust a length of the interface device 108 to account for the first object 110 being positioned at different distances from the robot 102 (e.g., to account for the different features of the first object 110). The load system 104 is illustrated in FIGS. 4A-4C in an extended state.

With reference to FIG. 4A, the load system 104 may be positioned to cause the interface device 108 to engage with a top or generally horizontal surface of the first object 110. As used herein, the term “generally horizontal” refers to an angle that is substantially normal to the direction of gravity, such that the angle is within ±15 degrees of normal of the direction of gravity, unless otherwise specified. The control system 109 may adjust a height of the load system 104 and the length of the interface device 108 to position the interface device 108 above the first object 110 and then bring the interface device 108 down to cause the interface device 108 to engage with the top surface of the first object 110.

With reference to FIG. 4B, the load system 104 is positioned to cause the interface device 108 to engage with a generally vertical surface of the first object 110. As used herein, the term “generally vertical” refers to an angle that is substantially aligned with the direction of gravity, such that the angle is within ±15 degrees of the direction of gravity, unless otherwise specified. The control system 109 may adjust a height of the load system 104 to position the interface device 108 behind the first object 110 and then the extension member 118 may extend to cause the interface device 108 to engage with a side surface of the first object 110.

With reference to FIG. 4C, the interface device 108 includes multiple portions 411 configured to engage with different or opposite side surfaces of the first object 110. The load system 104 may be positioned to cause the portions 411 of the interface device 108 to engage with generally vertical surfaces of the first object 110. In the configuration shown in FIG. 4C, the portions 411 of the interface device 108 may extend or retract to change a distance between the portions 411 of the interface device 108 to permit the first object 110 to be positioned therein. Alternatively, a width of the body 416c may be adjusted to change a distance between the portions of the interface device 108 to permit the first object 110 to be positioned between the portions of the interface device 108. The control system 109 may adjust a height of the load system 104 and/or the extension member 118 may extend to position the first object 110 between the portions 411 of interface device 108. The distance between the portions 411 of the interface device 108 may be adjusted to cause the portions 411 of the interface device 108 to engage the side surfaces of the first object 110.

With combined reference to FIGS. 4A-4C, the interface device 108 or the portions 411 of the interface device 108 may include one or more suction cups 424 (e.g., vacuum cups) that engage with the surfaces of the first object 110. The suction cups 424 may apply a vacuum pressure on the surfaces of the first object 110 to draw the first object 110 toward the interface device 108 and to engage with the first object 110. As shown in FIG. 4A, the suctions cups 424 of the interface device 108 may apply the vacuum pressure on the top or upper surface. As shown in FIG. 4B, the suctions cups 424 of the interface device 108 may apply the vacuum pressure on the side or the generally vertical surfaces. As shown in FIG. 4C, the suctions cups 424 of the interface device 108 may apply the vacuum pressure on the sides or generally vertical surfaces. Not all instances of the suction cups 424 are numbered in FIGS. 4A-4C for ease of illustration.

The suction cups 424 may apply the vacuum pressure when the extension member 118 extends, retracts, or both to move the first object 110. The suction cups 424 may apply the vacuum pressure when the extension member 118 extends, retracts, or both to position the first object 110 on the robot 102 or to position the first object 110 off the robot 102. The vacuum pressure applied by the suction cups 424 may be strong enough to push or pull the first object 110 along a surface (e.g., a surface of the table 112). The vacuum pressure applied by the suction cups 424 may be strong enough to permit the load system 104 to lift the first object 110 off the surface (e.g., surface of the table 112).

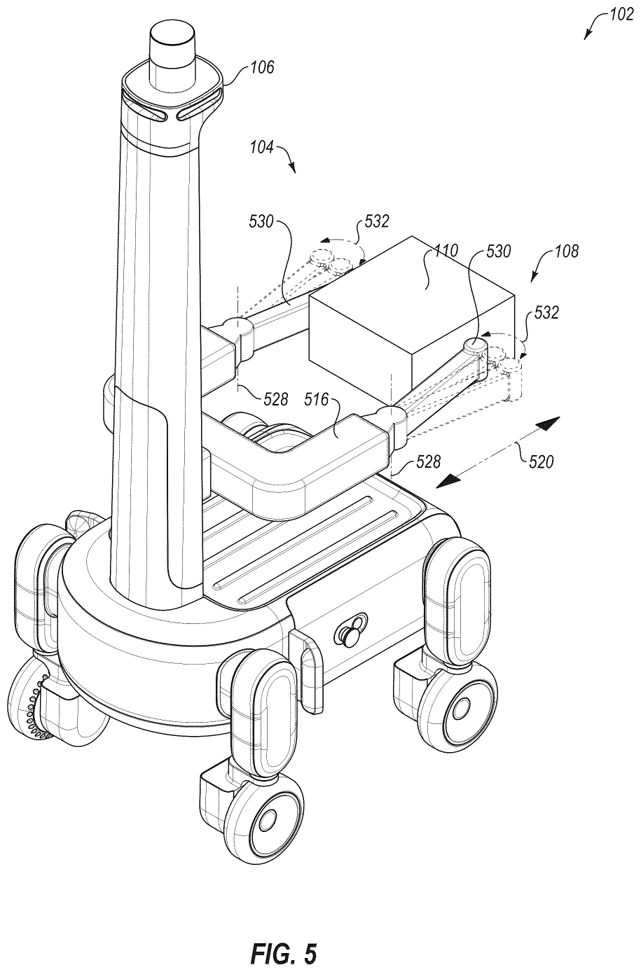

FIG. 5 illustrates another example of the robot 102 of FIG. 1 in which the load system 104 includes articulating interfaces 530, in accordance with at least one embodiment described in the present disclosure. The robot 102 includes the support portion 106 coupled to the load system 104. The load system 104 may include a body 516 coupled the support portion 106.

The interface device 108 may include the articulating interfaces 530 that operate as engaging portions or extension members. The articulating interfaces 530 may engage with the side surfaces or generally vertical surfaces of the first object 110. The articulating interfaces 530 may extend or retract to adjust a length or reach of the interface device 108. The articulating interfaces 530 may extend and retract to increase or decrease a distance between ends of the articulating interfaces 530 and the support portion 106. For example, the articulating interfaces 530 may extend or retract in directions indicated by arrow 520 in FIG. 5.

The control system 109 may cause the articulating interfaces 530 to extend or retract to adjust the reach or the length of the interface device 108 to account for the first object 110 being positioned at different distances from the robot 102 (e.g., to account for the different features of the first object 110). The articulating interfaces 530 extending or retracting may permit the interface device 108 to engage with the first object 110 at a variety of distances from the support portion 106.

The load system 104 may be positioned to permit the articulating interfaces 530 to engage with the first object 110. In the configuration shown in FIG. 5, the articulating interfaces 530 may pivot or rotate around axes 528 to change a distance between ends of the articulating interfaces 530 as shown by the dashed lines. The distance between ends of the articulating interfaces 530 may be adjusted to permit the first object 110 to be positioned between the articulating interfaces 530. Alternatively, a width of the body 516 may be adjusted to change a distance between the articulating interfaces 530 to permit the first object 110 to be positioned between the articulating interfaces 530. The control system 109 may adjust a height of the load system 104 and/or the articulating interfaces 530 may extend to position the first object 110 between the articulating interfaces 530. The distance between the articulating interfaces 530 may be adjusted to bring the articulating interfaces 530 proximate to the side surfaces of the first object 110.

The articulating interfaces 530 may pivot or rotate around the axes 528 to facilitate movement (e.g., to articulate) of the articulating interfaces 530 in directions indicated by arrows 532. The articulating interfaces 530 pivoting around the axes 528 may cause the articulating interfaces 530 to engage with the first object 110. The articulating interfaces 530 may sandwich (e.g., clamp) at least a portion of the first object 110. The articulating interfaces 530 may apply a force on side surfaces of the first object 110. The force applied by the articulating interfaces 530 may be strong enough to push or pull the first object 110 along a surface (e.g., a surface of the table 112). The force applied by the articulating interfaces 530 may be strong enough to permit the load system 104 to lift the first object 110 off the surface (e.g., the surface of the table 112).

The articulating interfaces 530 may apply the force when the articulating interfaces 530 extend, retract, or both to move the first object 110. The articulating interfaces 530 may apply the force when extending, retracting, or both to position the first object 110 on the robot 102 or position the first object 110 off the robot 102.

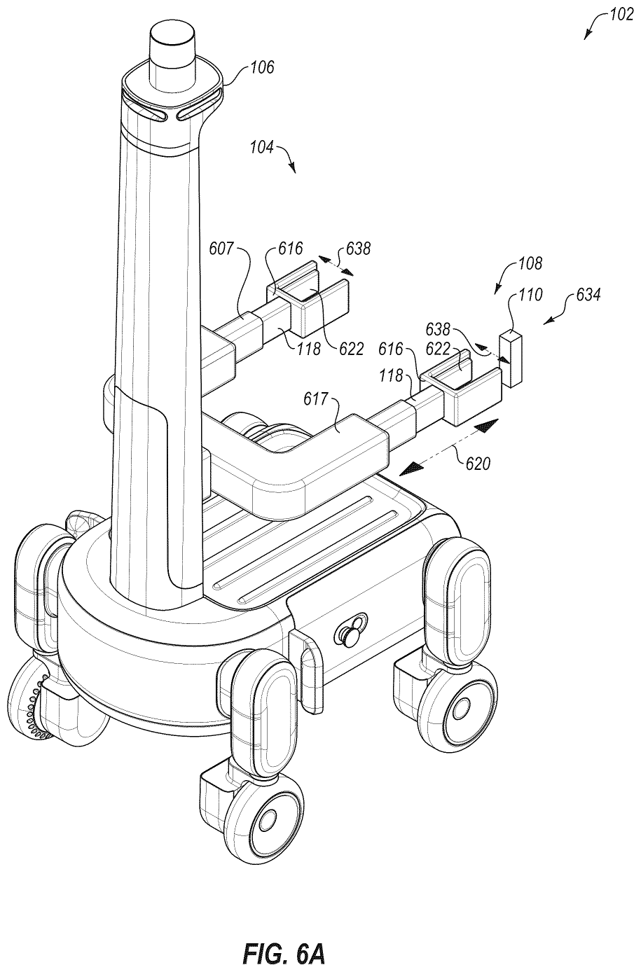

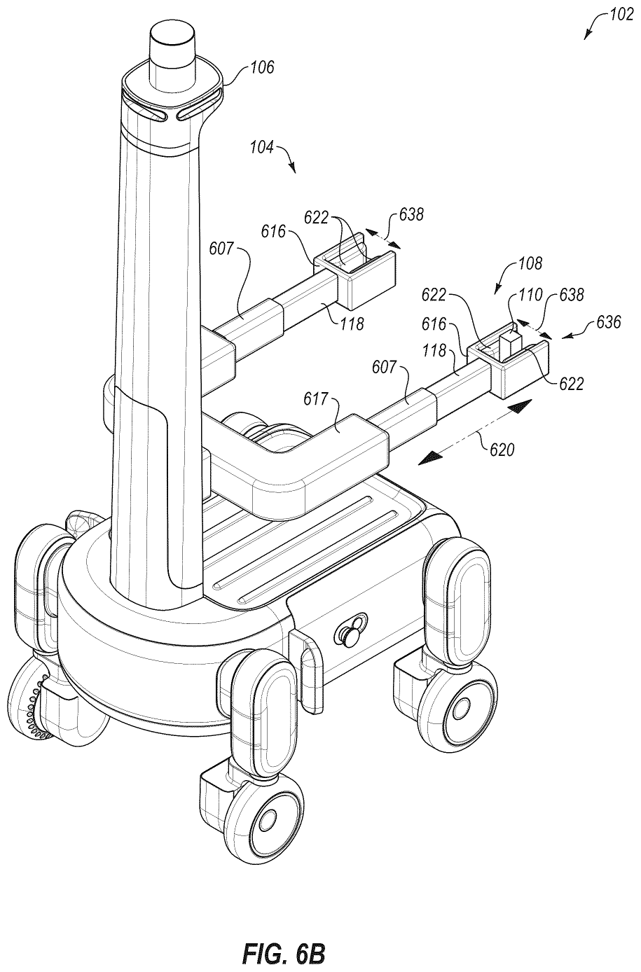

FIGS. 6A and 6B illustrate yet another example of the robot 102 of FIG. 1 in which the load system 104 includes expandable interface portions 622, in accordance with at least one embodiment described in the present disclosure. The expandable interface portions 622 may include one or more inflatable bladders that are configured to expand and contract to engage with side surfaces of the first object 110.

The robot 102 includes the support portion 106 coupled to the load system 104. The load system 104 may include arms 607 coupled to the support portion 106 via a body 617. The arms 607 may also be coupled to the interface device 108. The load system 104 may include the extension member 118 coupled to the interface device 108 and a body 616 of the load system 104.

The extension member 118 may extend and retract to increase or decrease a distance between the support portion 106 and ends of the arms 607 and/or the interface device 108. For example, the extension member 118 may extend or retract in directions indicated by arrow 620.

The arms 607 may move the load system 104 to different heights. For example, the control system 109 may activate actuators to move the body 617 along a height of the support portion 106 to cause the load system 104 to be moved to different heights. Moving the load system 104 to different heights may permit the interface device 108 to engage with the first object 110 at a variety of heights.

The load system 104 may be positioned to permit the expandable interface portions 622 to engage with generally vertical surfaces or side surfaces of the first object 110. In the configuration shown in FIGS. 6A and 6B, the expandable interface portions 622 may expand or contract to change a distance between the expandable interface portions 622 to permit the first object 110 to be positioned therein. Alternatively, a width of the body 616 may be adjusted to change a distance between the expandable interface portions 622 to permit the first object 110 to be positioned between the expandable interface portions 622.

The control system 109 may adjust a height of the load system 104 and/or the extension members 118 may extend to position the first object 110 between the expandable interface portions 622. The distance between the expandable interface portions 622 may be adjusted to permit the first object 110 to be positioned between the expandable interface portions 622 or position the expandable interface portions 622 proximate to the side surfaces of the first object 110.

The expandable interface portions 622 may expand in directions indicated by arrows 638 to apply a force on the side surfaces of the first object 110. The force applied by the expandable interface portions 622 may be strong enough to push or pull the first object 110 along a surface (e.g., a surface of the table 112). The force applied by the expandable interface portions 622 may be strong enough to permit the load system 104 to lift the first object 110 off the surface (e.g., the surface of the table 112). The expandable interface portions 622 may apply the force when the extension member 118 extends, retracts, or both to move the first object 110.

The expandable interface portions 622 are shown in a retracted (e.g., standard) state 634 in FIG. 6A and an extended state 636 in FIG. 6B. In the retracted state 634, the expandable interface portions 622 may be contracted to increase the distance between the expandable interface portions 622. The expandable interface portions 622 may initially be contracted to permit the first object 110 to enter an opening defined by the expandable interface portions 622. To transition to the extended state 636, the expandable interface portions 622 may inflate to expand and engage with side surfaces of the first object 110.

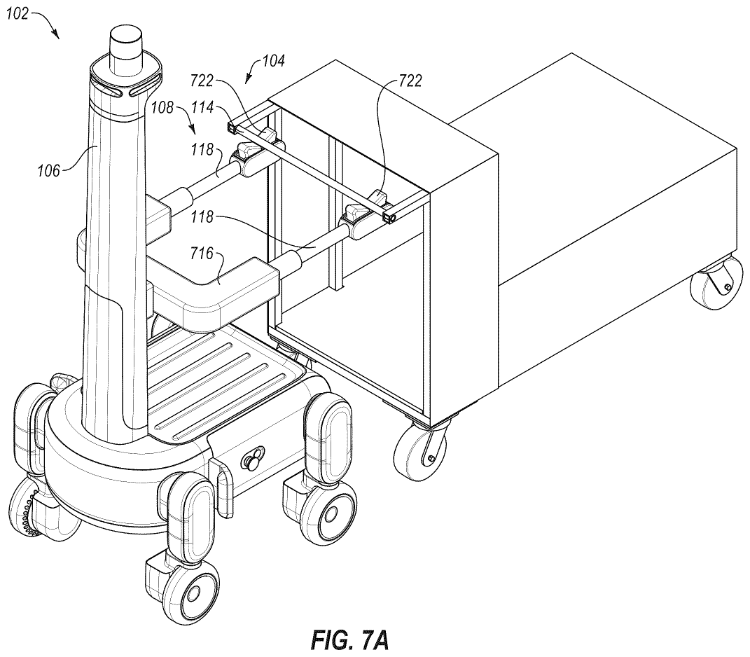

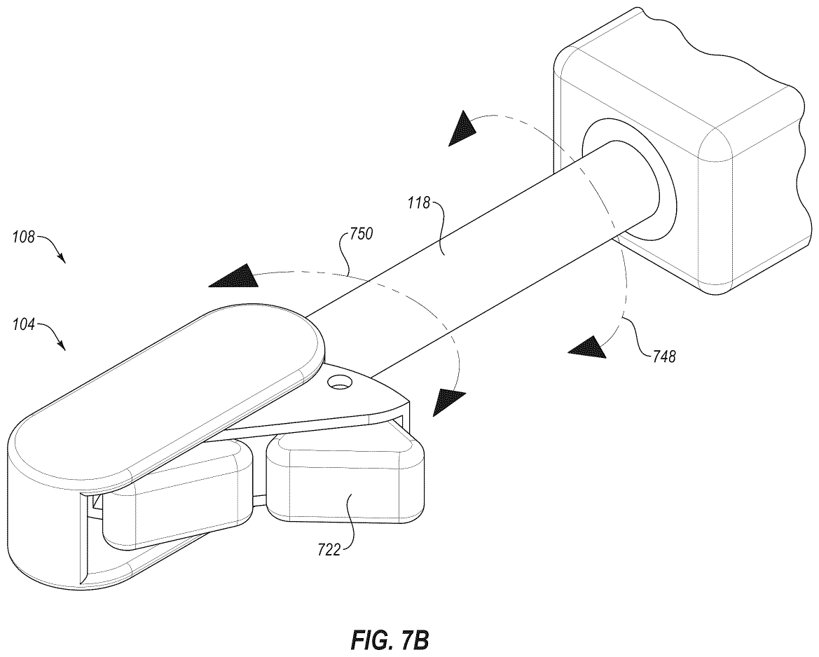

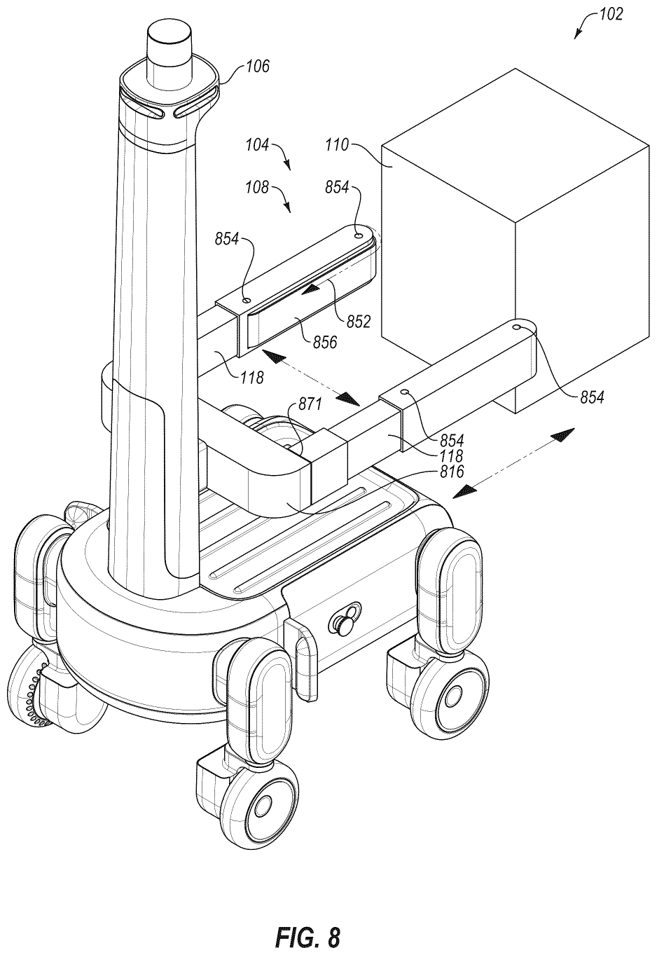

FIGS. 7A and 7B illustrate an example of the robot 102 of FIG. 1 in which the load system 104 includes two or more fractal devices 722, in accordance with at least one embodiment described in the present disclosure. The robot 102 includes the support portion 106 coupled to the load system 104. The load system 104 may include a body 716 coupled to the support portion 106 and the interface device 108. The load system 104 may include the extension member 118 coupled to the interface device 108 and the body 716.

The load system 104 may be positioned to permit the fractal devices 722 to engage with surfaces of the first object 110 or with the handle of the second object 114 (as shown in FIG. 7A). In the configuration shown in FIGS. 7A and 7B, the interface device 108 may pivot or rotate around axes to move in directions indicated by arrow 748 in FIG. 7B to change a distance between the fractal devices 722 to permit the first object 110 to be positioned between the fractal devices. Alternatively, a width of the body 716 may be adjusted to change a distance between the fractal devices 722 to permit the first object 110 to be positioned between the fractal devices 722. The control system 109 may adjust a height of the load system 104 and/or the extension member 118 may extend to position the first object 110 between or on the fractal devices 722. When engaging with the first object 110, the distance between the fractal devices 722 may be adjusted to cause the fractal devices 722 to engage with the side surfaces of the first object 110.

The fractal devices 722 may engage with the first object 110 when the first object 110 includes generally flat or smooth surfaces. Additionally or alternatively, the fractal devices 722 may engage with the first object 110 when surfaces of the first object 110 include irregularities such as protrusions, bumps, lumps, projections, or any other irregularity. Further, the fractal devices 722 may engage with the handle of the second object 114.

The fractal devices 722 may be configured to independently move to at least partially conform to profiles of the objects 110, 114. For example, the fractal devices 722 may conform to a flat, smooth, or curved surface of the first object 110. As another example, the fractal devices 722 may conform to protrusions, bumps, lumps, projections, or any other irregularity of a surface of the first object 110. As yet another example, the fractal devices 722 may conform to curves or shapes of the handle of the second object 114.

The interface device 108 may pivot or rotate around axes to move in directions indicated by the arrow 748 in FIG. 7B to facilitate movement (e.g., to articulate) of the fractal devices 722. The interface device 108 may pivot or rotate to cause the fractal devices 722 to apply a force on the sides of the first object 110. The force applied on the sides of the first object 110 may cause the fractal devices 722 to conform to the profile of the first object 110. In addition, the fractal devices 722 may pivot or rotate around different axes to move in directions indicated by arrow 750 to engage with the objects 110, 114. The interface device 108 pivoting or rotating around the different axes may permit the fractal devices 722 to engage with the objects 110, 114 at different angles relative to each other.

The fractal devices 722 may apply the force to permit the fractal devices 722 to manipulate the objects 110, 114. The force applied by the fractal devices 722 may be strong enough to push or pull the first object 110 along a surface (e.g., a surface of the table 112). In addition, the force applied by the fractal devices 722 may be strong enough to permit the load system 104 to lift the first object 110 off the surface (e.g., the surface of the table 112). The force applied by the fractal devices 722 may be strong enough to push or pull the second object 114.

The fractal devices 722 may apply the force when the extension member 118 extends, retracts, or both to move the objects 110, 114. The fractal devices 722 may apply the force when the extension member 118 is extending, retracting, or both to position the first object 110 on the robot 102 or position the first object 110 off the robot 102.

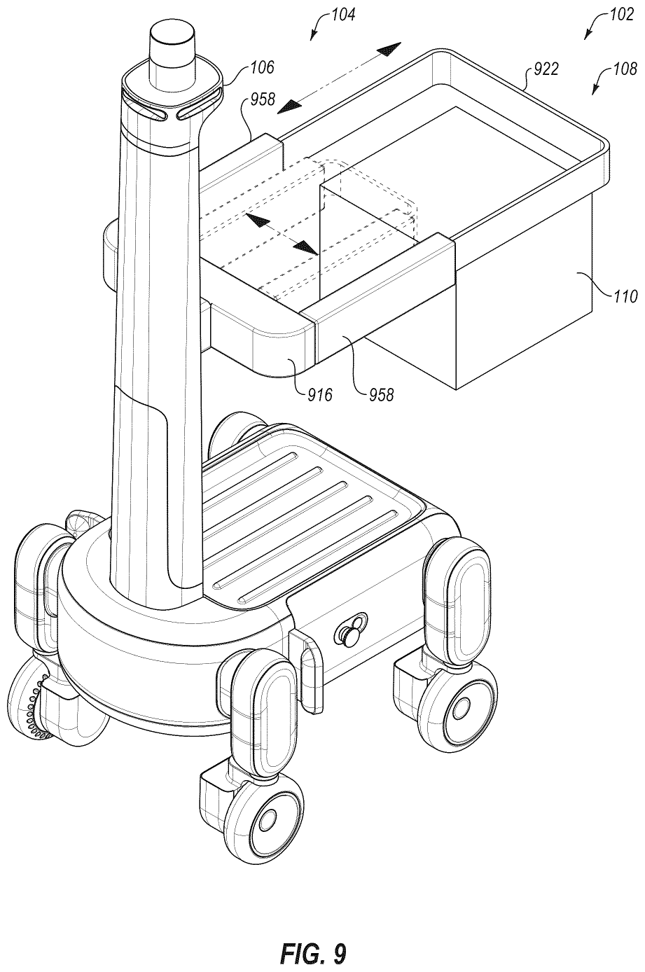

FIG. 8 illustrates another example of the robot 102 of FIG. 1 in which the load system 104 includes belts 856 and tensioners 854, in accordance with at least one embodiment described in the present disclosure. The robot 102 includes the support portion 106 coupled to the load system 104. The load system 104 may include the extension member 118 coupled to the interface device 108. The load system 104 may include a body 816 coupled to the extension member 118 and the support portion 106.

The belts 856 may extend along a portion of the extension members 118. The load system 104 may be positioned to permit the belts 856 to engage with side surfaces or generally vertical surfaces of the first object 110. A distance between the extension member 118 may be adjusted to change a distance between the belts 856 to permit the first object 110 to be positioned between the belts 856. For example, the load system 104 may include joints 871 at which the extension member 118 may move to increase or decrease the width of the body 816. The control system 109 may adjust a height of the load system 104 and/or the extension member 118 may extend to position the first object 110 between the belts 856. The distance between the extension member 118 may be adjusted to cause the belts 856 to engage the side surfaces of the first object 110.

The load system 104 may include one or more tensioners 854 per belt 856. The tensioners 854 may apply tension on the belts 856 such that when the tensioners 854 rotate, the belts 856 also rotates. The belts 856 may rotate in a direction as indicated by arrow 852 to manipulate the first object 110. Additionally, the belts 856 may rotate in a direction that is opposite to the direction indicated by arrow 852 to manipulate the first object 110. The belts 856 may apply a force on side surfaces of the first object 110. The force applied by the belts 856 may be strong enough to push or pull the first object 110 along a surface (e.g., a surface of the table 112).

FIG. 9 illustrates yet another example of the robot 102 of FIG. 1 in which the load system 104 includes an interface portion 922, in accordance with at least one embodiment described in the present disclosure. The robot 102 includes the support portion 106 coupled to the load system 104. The load system 104 may include support members 958 coupled to the interface device 108. The load system 104 may include a body 916 coupled to the support members 958 and the support portion 106.

The interface portion 922 may operate as engaging portions or extension members. In some embodiments, the interface portion 922 may include a metal tape. The interface portion 922 may extend from distal ends of the support members 958. The interface portion 922 may be configured to engage with sides of the first object 110. For example, the interface portion 922 may include an anisotropic material or metastable structure having directional flexibility in a first direction (e.g., a direction along a width of the robot 102) and a directional rigidity in a second direction (e.g., a direction along a height of the robot 102). As another example, the interface portion 922 may include an anisotropic material or metastable structure that is rigid along one axis, flexible along another axis, and returns to an original shape after being bent to permit the interface portion 922 to extend from the support members 958 without collapsing and to adjust along with the adjustment of the width of the body 916.

The interface portion 922 may extend or retract to adjust a length or reach of the interface device 108. The interface portion 922 may extend and retract to increase or decrease a distance between the interface portion 922 and the body 916. The interface portion 922 extending or retracting may permit the interface device 108 to engage with the first object 110 at a variety of distances from the support portion 106.

A distance between the support members 958 may be sized or adjustable as shown by the dashed lines to cause the interface portion 922 to engage with instances of the first object 110 with different widths. The interface portion 922 may engage with the sides of the first object 110 to apply a force on the first object 110 to draw the first object toward the robot 102. The force applied by the interface portion 922 may be strong enough to push or pull the first object 110 along a surface (e.g., a surface of the table 112).

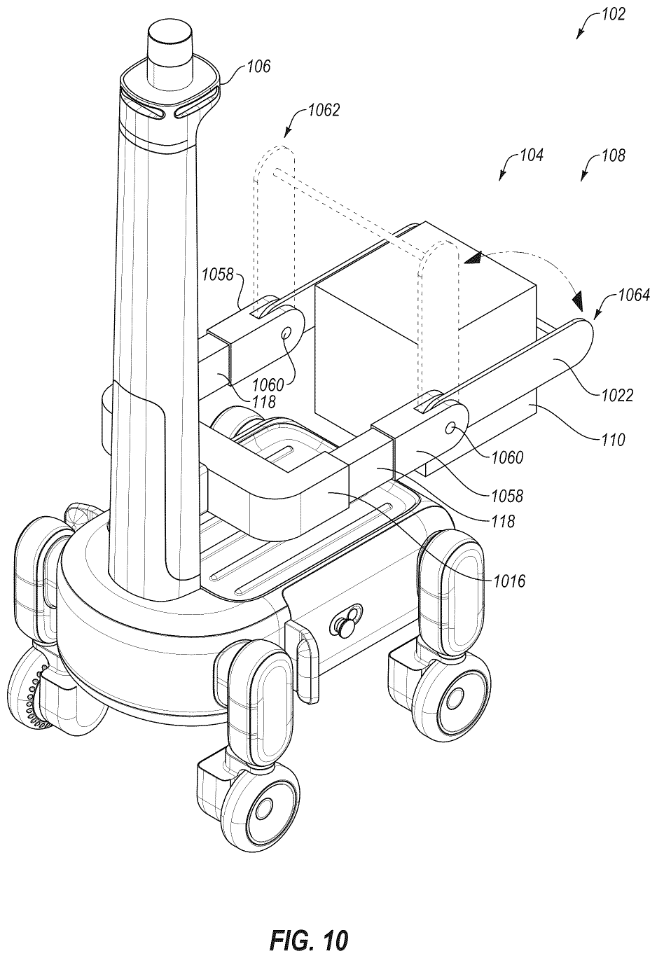

FIG. 10 illustrates a further example of the robot 102 of FIG. 1 in which the load system 104 includes a rotatable interface portion 1022, in accordance with at least one embodiment described in the present disclosure. The robot 102 includes the support portion 106 coupled to the load system 104. The load system 104 may include support members 1058 coupled to the rotatable interface portion 1022. The load system 104 may include a body 1016 coupled to the extension member 118 or the support members 1058 and the support portion 106.

The load system 104 may be positioned to permit the rotatable interface portion 1022 to engage with side surfaces or generally vertical surfaces of the first object 110. The rotatable interface portion 1022 may pivot or rotate around an axis 1060 to facilitate movement of the rotatable interface portion 1022. The rotatable interface portion 1022 may pivot or rotate around the axis 1060 to cause the rotatable interface portion 1022 to transition between a load/unload state 1062 (shown in FIG. 10 in dashed lines) and a loaded state 1064 (shown in FIG. 10 as solid lines). In the load/unload state 1062, the first object 110 may fit underneath the rotatable interface portion 1022 and between the support members 1058. In the loaded state 1064, the rotatable interface portion 1022 may move down to prevent the first object 110 from falling or otherwise moving. In the loaded state 1064, the rotatable interface portion 1022 may engage with the side surfaces or generally vertical surfaces of the first object 110.

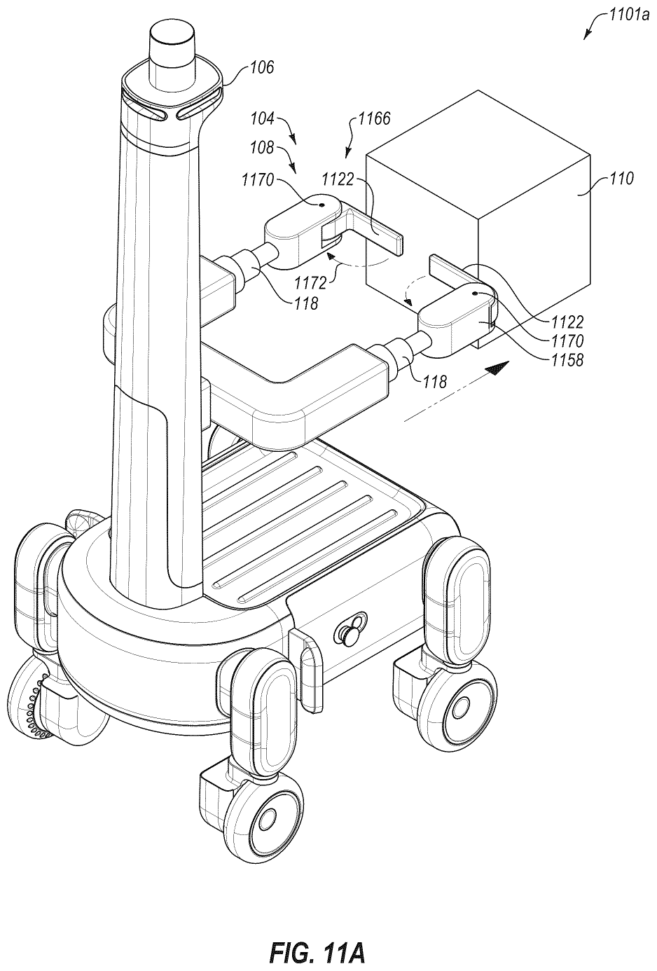

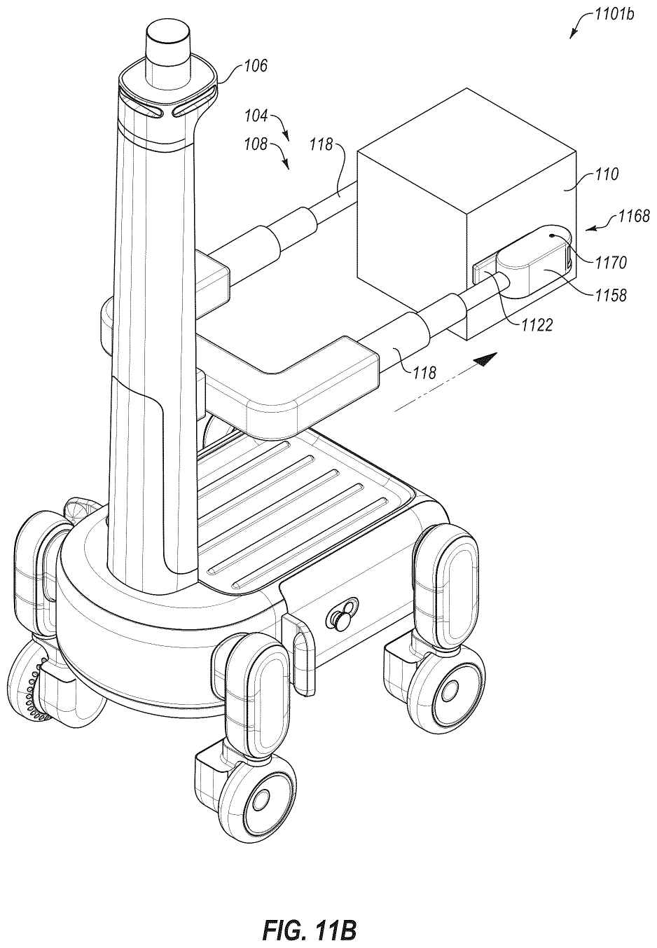

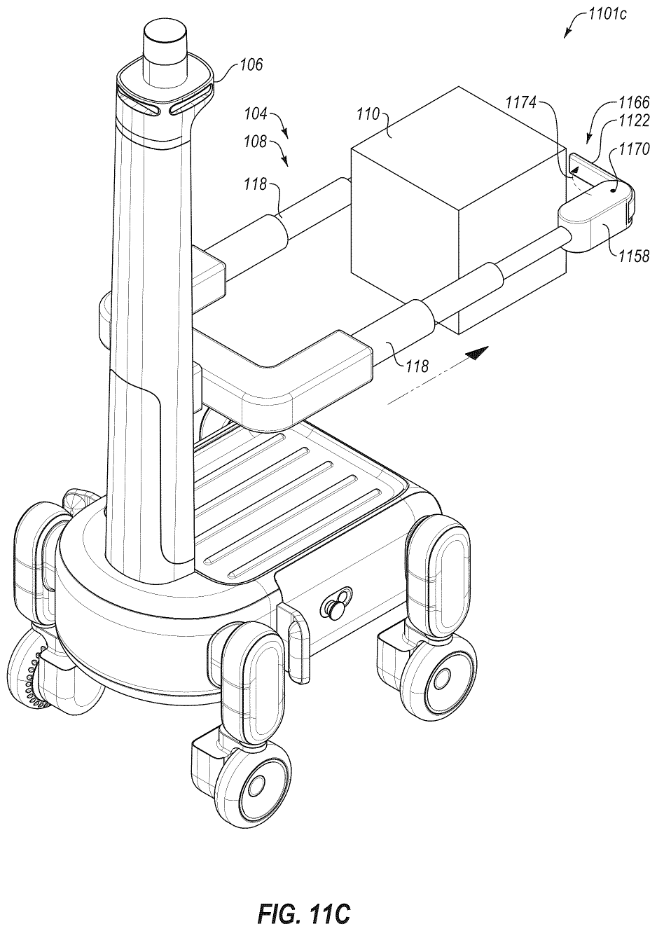

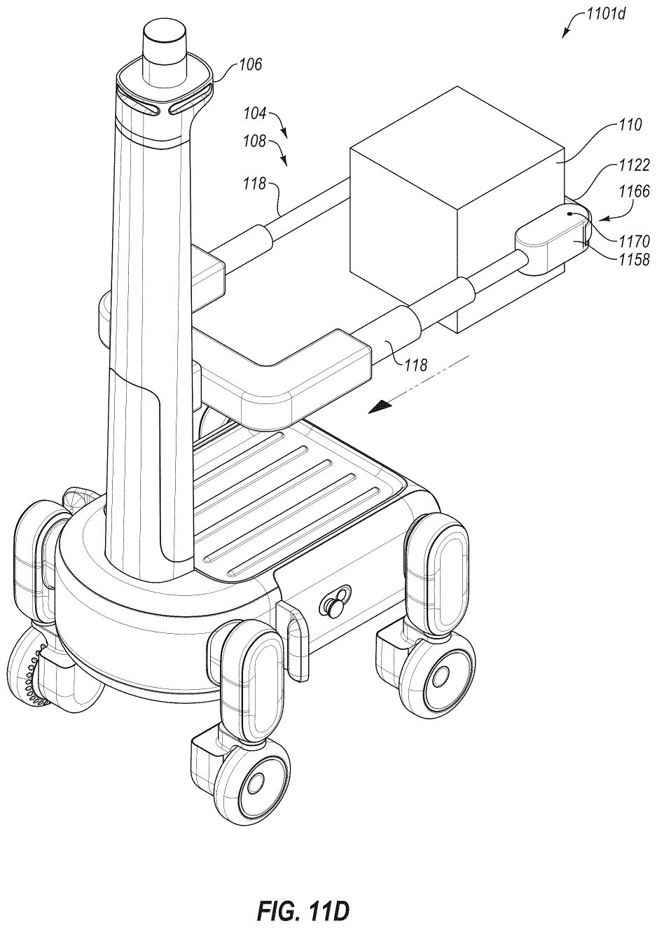

FIGS. 11A-11D illustrate a sequence of views 1101a-d of an example interface device 108 that includes a rotatable portion 1122, in accordance with at least one embodiment described in the present disclosure. The interface device 108 may include a support member 1158 coupled to the rotatable portion 1122. The rotatable portion 1122 may be positioned proximate to a distal end of the support member 1158. The rotatable portion 1122 may include a paddle portion configured to engage with sides of the first object 110. The support member 1158 may be coupled to the robot 102, the support portion 106, or as shown in FIGS. 11A-11D, the extension member 118.

The rotatable portion 1122 may pivot or rotate around an axis 1170 to facilitate movement of the rotatable portion 1122. The rotatable portion 1122 may pivot or rotate around the axis 1170 to cause the rotatable portion 1122 to transition between an unfolded state 1166 shown in FIGS. 11A, 11C, and 11D and a folded state 1168 shown in FIG. 11B. In the folded state 1168, the rotatable portion 1122 may fold (e.g., the paddle portion may move in a direction indicated by arrow 1172 in FIG. 11A) to form a generally flush surface such that the rotatable portion 1122 may pass by the first object 110 without engaging the first object 110. When transitioning from the folded state 1168 to the unfolded state 1166, the rotatable portion 1122 may move in a direction indicated by arrow 1174 shown in FIG. 11C to form an angle such that a paddle portion extends parallel to an axis of the support member 1158 to cause the rotatable portion 1122 to engage with the first object 110.

In the first view 1101a, the interface device 108 is in the unfolded state 1166 and is moving towards the first object 110. In the second view 1101b, the interface device 108 (e.g., the rotatable portion 1122) has contacted the first object 110 and transitioned to the folded state 1168. In the third view 1101c, the interface device 108 has passed an end of the first object 110 and is transitioning from the folded state 1168 to the unfolded state 1166. In the fourth view 1101d, the interface device 108 is moving back towards the robot 102 and drawing the first object 110 towards the robot 102. In the fourth view 1101d, the interface device 108 is in the unfolded state 1166.

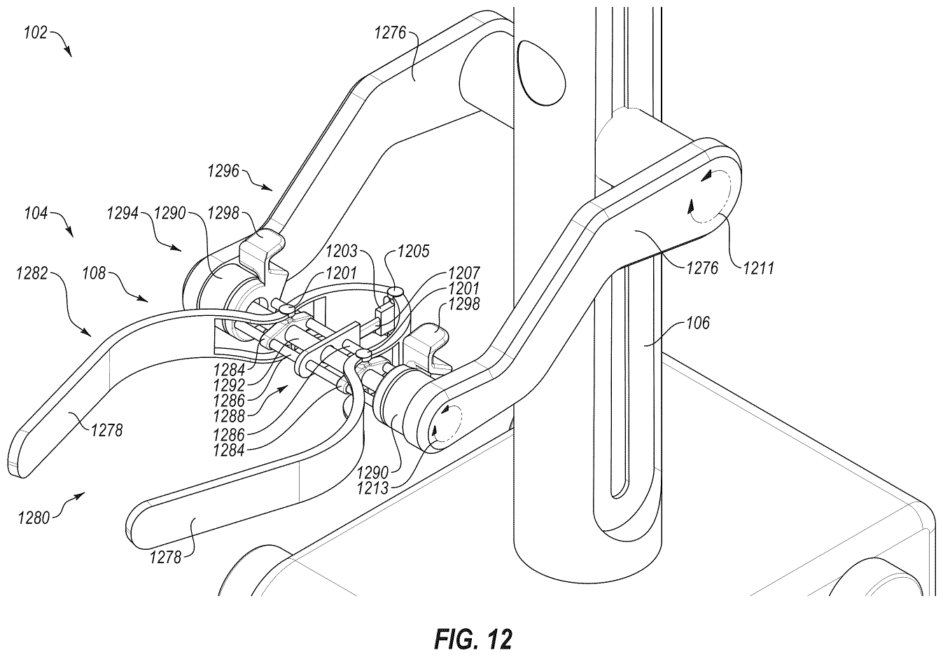

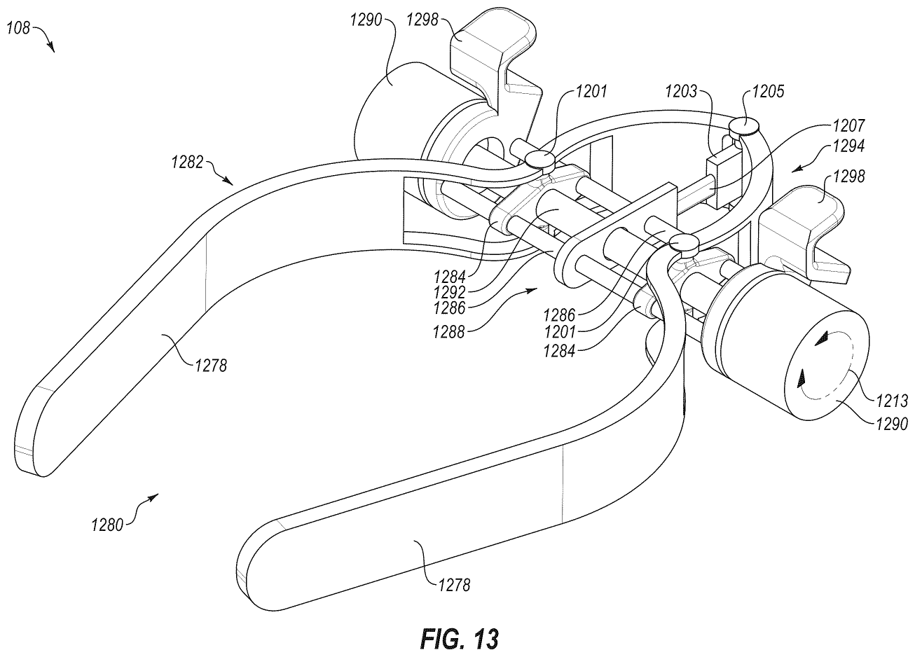

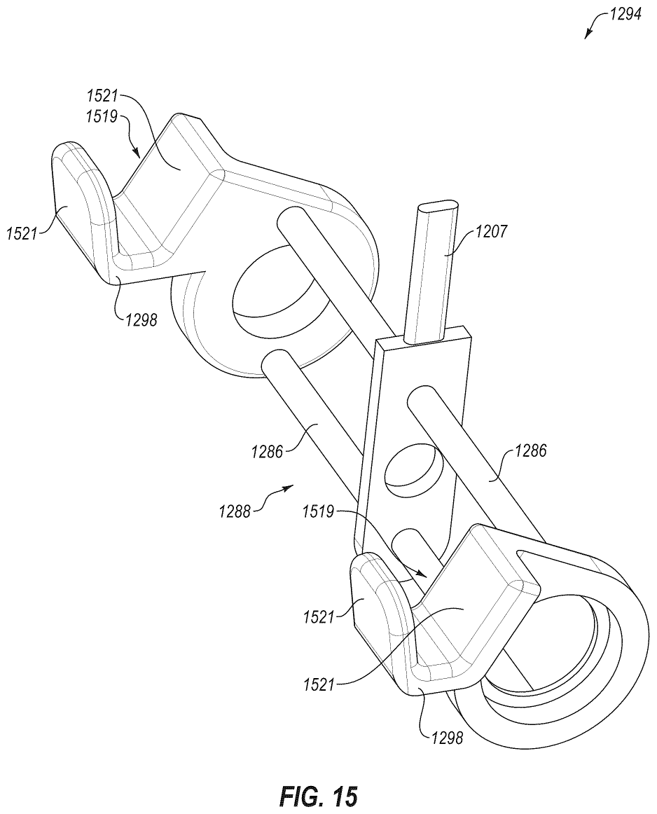

FIGS. 12-16B illustrate another example of the robot 102 of FIG. 1 in which the load system 104 includes an appendage assembly 1296, in accordance with at least one embodiment described in the present disclosure.

With combined reference to FIGS. 12-16B, the load system 104 may be coupled to the support portion 106. The appendage assembly 1296 may be coupled to the support portion 106. The appendage assembly 1296 may include arms 1276 coupled to the support portion 106.

The appendage assembly 1296 may include an actuator (not shown) configured to move the appendage assembly 1296. The actuator may move the appendage assembly 1296 such that the appendage assembly 1296 pivots around an axis and moves relative to the support portion 106. The actuator may move the appendage assembly 1296 in directions indicated by arrow 1211 shown in FIG. 12.

The interface device 108 may be coupled at or proximate distal ends of the arms 1276. The interface device 108 may extend between the arms 1276 to couple the arms 1276 to each other. The interface device 108 may include actuators 1290 that are coupled to the arms 1276.

The actuators 1290 may move the interface device 108 relative to the appendage assembly 1296. The actuators 1290 may move the interface device 108 to permit an interface assembly 1282 or an interface feature 1294 to engage with the objects 110, 114. The actuators 1290 may move the interface device 108 such that the interface device 108 pivots around an axis to change an orientation of the interface assembly 1282 and the interface feature 1294. For example, the actuators 1290 may move the interface device 108 to put the interface assembly 1282 in a position to engage with the first object 110. As another example, the actuators 1290 may move the interface device 108 to cause the interface feature 1294 to engage with the second object 114.

The actuators 1290 may move the interface device 108 to prevent one of the interface assembly 1282 and the interface feature 1294 from engaging the objects 110, 114. For example, the actuators 1290 may move the interface device 108 to position the interface assembly 1282 to avoid the objects 110, 114. As another example, the actuators 1290 may move the interface device 108 to position the interface feature 1294 to avoid the objects 110, 114. The actuators 1290 may move the interface device 108 in directions indicated by arrow 1213.

The appendage assembly 1296, the interface device 108, or both may move to cause the interface device 108 to engage with the objects 110, 114. The appendage assembly 1296, the interface device 108, or both may move to permit the interface device 108 to engage with the objects 110, 114 when the objects 110, 114 include different features.

The interface assembly 1282 may engage with the first object 110. For example, the interface assembly 1282 may include members 1278 that engage with sides or other surfaces of the first object 110. The members 1278 may define an adjustable opening 1280 that is configured to receive the first object 110. The interface feature 1294 may engage with the handle of the second object 114. For example, the interface feature 1294 may include engagement elements 1298 that are configured to receive the handle of the second object 114.

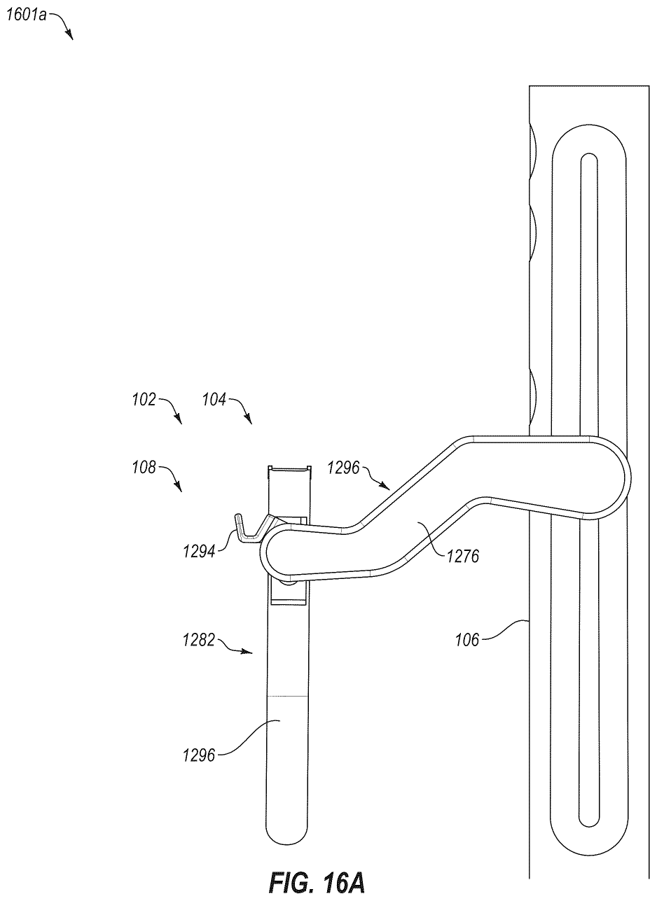

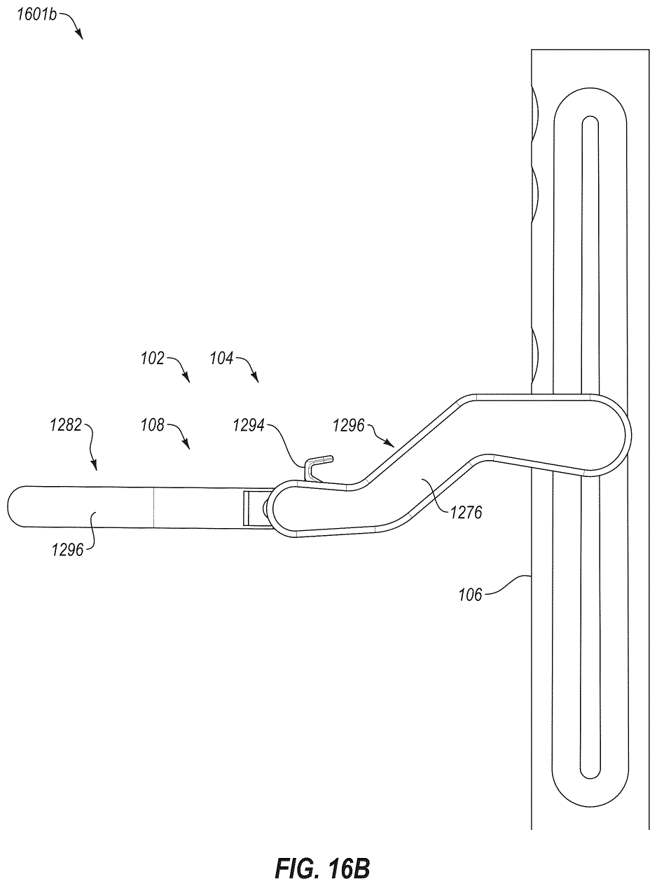

As shown in FIG. 16B, the interface device 108 may move such that the interface assembly 1282 extends in a direction away from the support portion 106 to permit the interface assembly 1282 to engage with the first object 110. As shown in FIG. 16A, the interface device 108 may move such that interface assembly 1282 extends in a downward direction and out of the way of the interface feature 1294 to permit the interface feature 1294 to engage with the handle of the second object 114. The positions of the interface assembly 1282 and the interface feature 1294 are described in more detail below in relation to FIGS. 16A and 16B.

With combined reference to FIGS. 12-15, the members 1278 may be coupled to parts 1284 of the interface assembly 1282 via joints 1201. The joints 1201 may pivot (e.g., rotate) relative to different axes to facilitate movement of the members 1278. The members 1278 may be coupled to each other, a limiter 1203, or both via a joint 1205. The joint 1205 may pivot relative to another axis to facilitate movement of the members 1278.

The interface feature 1294 may include the engagement elements 1298 to engage with the handle of the second object 114. The engagement elements 1298 may define openings 1519 that are configured to receive the handle of the second object 114. When the engagement elements 1298 engage the second object 114, the handle of the second object 114 may rest in the openings 1519 and digits 1521 of the engagement elements 1298 may prevent the handle from exiting the openings 1519 in a forward or backward direction.

The interface device 108 may include a crossbar device 1288 coupled to the interface assembly 1282, the interface feature 1294, or both. The crossbar device 1288 may extend along the axis around which the interface device 108 pivots.

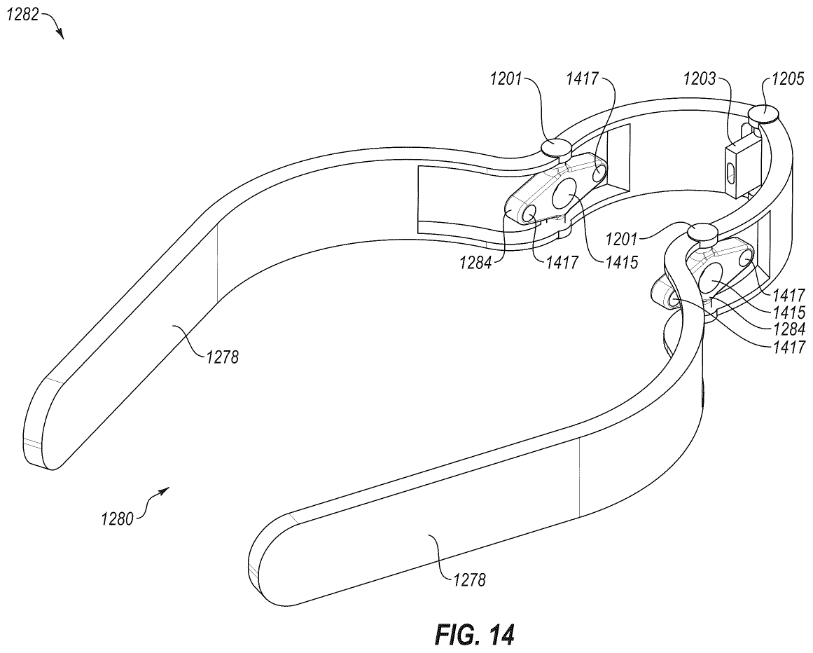

The crossbar device 1288 may include extension parts 1286 that are coupled to the appendage assembly 1296. The extension parts 1286 may extend through openings 1417 shown in FIG. 14 defined by the parts 1284. The crossbar device 1288 may include a rod 1292. The rod 1292 may extend through openings 1415 shown in FIG. 14 defined by the parts 1284. The extension parts 1286 and the rod 1292 may extend along the second axis.

The actuators 1290 may cause the crossbar device 1288 to pivot around the axis to change the orientation of the interface device 108. The actuators 1290 may cause the crossbar device 1288 to move and cause the interface device 108 to move due to the coupling between the parts 1284, the extension parts 1286, or the rod 1292. The extension parts 1286 and the engagement elements 1298 may form a unitary piece of material. The extension parts 1286 may be attached to the engagement elements 1298 through any appropriate means.

The rod 1292 may engage with the openings 1415 defined by the parts 1284 to change a distance between the parts 1284 and adjust a width of the adjustable opening 1280. The openings 1415 may include threaded surfaces that are configured to engage with threads of the rod 1292. When the rod 1292 rotates, the parts 1284 may move along a length of the rod 1292 and change the distance between the parts 1284. For example, the openings 1415 may include opposite threading such that when the rod 1292 rotates in a clockwise direction, the parts 1284 move towards each other. As another example, the openings 1415 may include the opposite threading such that when the rod 1292 rotates in a counterclockwise direction, the parts 1284 may move away from each other.

The interface device 108 may include the limiter 1203 to prevent the size of the adjustable opening 1280 from being changed beyond a minimum size or a maximum size. For example, the limiter 1203 may include a rod, a bar, or other type of extended portion (referred to in the present disclosure as the rod 1207) that engages with other parts. When the rod 1207 engages with the other parts, movement of the members 1278, rotation of one or more of the joints 1201, 1205 may be prevented.

Referring to FIGS. 16A and 16B, multiple views 1601a-b of different configurations of the appendage assembly 1296 are shown. The first view 1601a shows the interface device 108 such that the interface feature 1294 is positioned to engage with the second object 114. The first view 1601a shows the interface device 108 such that the interface assembly 1282 is positioned out of the way of the second object 114 to prevent the interface assembly 1282 from unintentionally engaging the second object 114. When in the configuration shown in the first view 1601a, the appendage assembly 1296 may move to position the interface feature 1294 to position the handle of the second object 114 within the openings 1519.

The second view 1601b shows the interface device 108 such that the interface assembly 1282 is positioned to engage with the first object 110. The second view 1601b shows the interface device 108 such that the interface feature 1294 is positioned out of the way of the first object 110 to prevent the interface assembly 1282 from unintentionally engaging the first object 110. When in the configuration shown in the second view 1601b, the actuators 1290 may move the interface device 108 to cause the arms 1276 to engage with the first object 110.

With reference to FIGS. 1-15, the support portion 106 may move between different positions (e.g., angles). In each of the positions, the load system 104 may be permitted to engage with the objects 110, 114 at different heights, angles, or both.

When the support portion 106 is angled back, a front surface of the support portion 106 may be at an obtuse angle (e.g., an angle that is greater than ninety degrees) relative to a ground surface. When angled back, the load system 104 may be able to angle or position the first object 110 on a higher surface than when angled forward or perpendicular relative to the ground surface. Additionally or alternatively, when angled back, the load system 104 may angle the first object 110 to prevent contents from spilling forward.

When the support portion 106 is angled generally perpendicular to the ground surface, the load system 104 may position the first object 110 such that the robot 102 can traverse the environment 100 while carrying the first object 110. As used herein, the term “generally perpendicular” means any angle between eighty degrees and one hundred ten degrees relative to the ground surface.

When the support portion 106 is angled forward, the front surface of the support portion 106 may be at an acute angle (e.g., an angle that is less than ninety degrees) relative to the ground surface. When angled forward, the load system 104 may pick up or place the first object 110 on a lower surface than when angled back or perpendicular to the ground surface.

The width of the bodies 416a-c, 516, 616, 716, 816, 916, 1016 may be adjusted using cables, pulleys, flexure drives, or any other appropriate technique (generally referred to as “cable system” in the present disclosure). The control system 109 may control the cable system to draw portions of the bodies 416a-c, 516, 616, 716, 816, 916, 1016 or the support member 958, 1058, 1158 towards each other. The control system 109 may control the cable system to draw the portions of the bodies 416a-c, 516, 616, 716, 816, 916, 1016 or the support member 958, 1058, 1158 towards each other to cause the interface device 108 to engage with instances of the first object 110 that include different widths.

The load system 104 may include asymmetric effectors. For example, one effector may include the ones discussed above in relation to FIGS. 2-8 (referred to as the first effector) and a second effector that includes a tray, platform, or any other appropriate structure to engage with a bottom surface of the first object 110. The first effector may lift a portion of the first object 110 off the surface of the table 112 to permit the second structure to be positioned between the first object 110 and the table 112.

The extension member 118 may extend and retract to facilitate movement of the first effector and the second effector. The extension member 118 may extend and retract to cause the load system 104 to transition between a retracted state, an intermediate state, and a loaded state.

In the intermediate state, the load system 104 may be transitioning from the retracted state or from the loaded state. When transitioning from the retracted state, the extension member 118 may extend to cause the first effector to engage with an edge, a corner, or upper portion of the first object 110 so as lift a portion of the first object 110 and create a gap between the table 112 and the first object 110. The gap between the table 112 and the first object 110 may permit the second effector to be positioned between the first object 110 and the table 112. In the loaded state, the first effector and the second effector may sandwich a portion of the first object 110 to move or lift the first object 110.

FIG. 17 illustrates an example computing system 1700 that may be used by the robot 102 to position the load system 104, in accordance with at least one embodiment of the present disclosure. The computing system 1700 may be configured to implement or direct one or more operations associated with operations of the robot 102, which may include operation of the control system 109 or the robot 102. The computing system 1700 may include a processor 1702, a memory 1704, a data storage 1706, and a communication unit 1708, which all may be communicatively coupled. The computing system 1700 may be part of any of the systems or devices described in this disclosure. For example, the computing system 1700 may be configured to perform one or more of the tasks described above with respect to control system 109 and/or the robot 102.

The processor 1702 may include any computing entity, or processing device including various computer hardware or software modules and may be configured to execute instructions stored on any applicable computer-readable storage media. For example, the processor 1702 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 17, it is understood that the processor 1702 may include any number of processors distributed across any number of networks or physical locations that are configured to perform individually or collectively any number of operations described herein.

The processor 1702 may be configured to interpret and/or execute program instructions and/or process data stored in the memory 1704, the data storage 1706, or the memory 1704 and the data storage 1706. The processor 1702 may fetch program instructions from the data storage 1706 and load the program instructions in the memory 1704. After the program instructions are loaded into memory 1704, the processor 02 may execute the program instructions.

For example, the processor 1702 may be configured to interpret and/or execute program instructions and/or process data stored in the memory 1704, the data storage 1706, or the memory 1704 and the data storage 1706. The program instruction and/or data may be related to the control system 109 such that the computing system 1700 may perform or direct the performance of the operations associated therewith as directed by the instructions.

The memory 1704 and the data storage 1706 may include computer-readable storage media or one or more computer-readable storage mediums for carrying or having computer-executable instructions or data structures stored thereon. Such computer-readable storage media may be any available media that may be accessed by a computer, such as the processor 1702.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 1702 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500F.3 d 1346 (Fed. Cir. 2007). Combinations of the above may also be included within the scope of computer-readable media.

The communication unit 1708 may include any component, device, system, or combination thereof that is configured to transmit or receive information over a network. The communication unit 1708 may communicate with other devices at other locations, the same location, or even other components within the same system. For example, the communication unit 1708 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 1708 may permit data to be exchanged with a network and/or any other devices or systems described in the present disclosure.

Modifications, additions, or omissions may be made to the computing system 1700 without departing from the scope of the present disclosure. For example, the computing system 1700 may include any number of other components that may not be explicitly illustrated or described. Further, depending on certain implementations, the computing system 1700 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A robot comprising:
a load system comprising an interface device configured to engage with objects comprising different features; and
a control system configured to:
detect a current feature of a current object; and
cause the load system to be positioned based on the current feature of the current object to cause the interface device to engage with the current object.

2. The robot of claim 1, wherein the control system causes the load system to be positioned to adjust a characteristic of the interface device to permit the interface device to engage with the current object when the current feature is different than a feature of a previous object.

3. The robot of claim 1, wherein the control system causes the load system to be positioned to accommodate the current object having different dimensions or configurations than a previous object.

4. The robot of claim 1 comprising a support portion coupled to the load system, wherein the control system causes the support portion to move the load system along a height of the support portion to adjust a height of the interface device to account for the different features of the objects.

5. The robot of claim 1, wherein:
the load system comprises an extension member coupled to the interface device; and
the control system causes the extension member to extend and retract to adjust a length of the interface device to account for the different features of the objects.

6. The robot of claim 1, wherein:
the load system comprises a body; and
the control system causes the body to be positioned to adjust a width of the body to permit the interface device to engage with the current object when the current feature comprises a width that is different a width of a previous object.

7. The robot of claim 1, wherein:
the interface device comprises a metal tape;
the control system causes the metal tape to be positioned to extend the metal tape and engage with the current object; and
the metal tape comprises an anisotropic material having directional flexibility in a first direction and a directional rigidity in a second direction.

8. The robot of claim 1, wherein:
the load system comprises an extension member;
the control system causes the extension member to extend to cause a first effector of the interface device to engage with an edge of the current object to create a gap between the current object and a surface on which the current object is positioned;
the control system causes the extension member to extend to cause a second effector of the interface device to be positioned in the gap between the current object and the surface;
the first effector and the second effector are configured to engage the current object by sandwiching a portion of the current object; and
the control system causes the extension member to retract or extend to engage the current object.

9. The robot of claim 1, wherein:
the interface device comprises a plurality of articulating interfaces; and
the control system causes the plurality of articulating interfaces to engage the current object by sandwiching a portion of the current object.

10. The robot of claim 1, wherein the control system is configured to cause the load system to be positioned to perform at least one of:
adjust a height of the load system;
extend and retract a length of the interface device; or
adjust a width of the load system.

11. The robot of claim 1, wherein the control system causes the load system to be positioned to cause the interface device to engage with a side surface of the current object.

12. The robot of claim 1, wherein the interface device comprises two or more fractal devices configured to conform to the current feature of the current object.

13. The robot of claim 1, wherein:
the interface device comprises a plurality of portions that are configured to transition between an extended state and a folded state;
in the extended state, the portions are positioned to form an angle to cause the interface device to engage with the current object; and
in the folded state, the portions are positioned to form a generally flush surface to permit the interface device to pass by the current object without engaging the current object.

14. A robot comprising:
a support portion; and
a load system coupled to the support portion, the load system comprising:
an interface device configured to engage with objects comprising different features; and
an appendage assembly configured to:
pivot around a first axis to permit a first link of the appendage assembly to move relative to the support portion;
pivot around a second axis to permit a second link of the appendage assembly to move relative to the first link; and
pivot around a third axis to permit a third link of the appendage assembly to move relative to the second link, wherein the appendage assembly is configured to pivot around the first axis, the second axis, and the third axis to position the load system and cause the interface device to engage with the objects comprising the different features.

15. The robot of claim 14 comprising a control system configured to:
detect a current feature of a current object; and
cause the appendage assembly to pivot around the first axis, the second axis, and the third axis based on the current feature of the current object to cause the interface device to engage with the current object.

16. The robot of claim 15, wherein:
the load system comprises a body coupled to the support portion and the appendage assembly; and
the control system causes the support portion to move the body along a height of the support portion to adjust a height of the load system to account for the different features of the objects.

17. The robot of claim 14, wherein the interface device comprises:
a first portion coupled to the appendage assembly via a rotational joint; and
a second portion coupled to the first portion, wherein:
the rotational joint is configured to rotate the interface device to change an orientation of the second portion to account for the different features of the objects; and
the second portion is configured to pivot around another axis to facilitate movement of the second portion relative to the first portion to account for the different features of the objects.

18. The robot of claim 14, wherein the interface device comprises a first gripper and a second gripper that are configured to transition between a curled state and a uncurled state to account for the different features of the objects.

19. The robot of claim 14, wherein:
the first link is configured to pivot around the first axis to change an orientation of the first link relative to the support portion independent of the second link and the third link and move the second link, the third link, and the interface device;
the second link is configured to pivot around the second axis to change an orientation of the second link relative to the first link independent of the first link and the third link and move the third link and the interface device; and
the third link is configured to pivot around the third axis to change an orientation of the third link relative to the second link independent of the first link and the second link and move the interface device.

20. The robot of claim 14, wherein the different features of the objects comprise at least one of shapes, sizes, orientations, or types of the objects.
